(19) United States
(12) Patent Application Publication
(10) Pub. No.: US 2017/0253345 A1
(43) Pub. Date: Sep. 7, 2017

(54) AIRCRAFT RECOVERY SYSTEMS

(71) Applicant: Cloud Cap Technology, Inc., Hood River, OR (US)

(72) Inventor: Gene I. Katz, Parkdale, OR (US)

(21) Appl. No.: 15/062,795

(22) Filed: Mar. 7, 2016

(51) Int. Cl. B64D 45/00; B64C 39/02

(52) U.S. Cl. CPC B64D 45/00; B64C 39/024; B64D 2045/0085

(57) ABSTRACT

A loss of communications system for an aircraft includes a fault module configured to detect a fault condition of the aircraft, and an emergency communication module configured to connect to a network, and to transmit condition data of the aircraft over the network when the fault condition is detected. The fault condition can include at least one of a loss of communication between the aircraft and a remote user or a forced landing of the aircraft. The condition data can include at least one of current location data, aircraft system health data, landing site location data, or landing site characteristics data.

### BACKGROUND

1. Field

The present disclosure relates to loss of communication systems aircraft, more specifically to recovery systems for aircraft.

2. Description of Related Art

In certain situations, loss of communication with an aircraft, e.g., and unmanned aerial vehicle (UAV), leads to loss of the aircraft position information and/or control. If the aircraft lands or crashes before communication can be regained, the only method for recovery is to search starting at the last point of contact.

Such conventional methods and systems have generally been considered satisfactory for their intended purpose. However, there is still a need in the art for aircraft recovery systems. The present disclosure provides a solution for this need.

### SUMMARY

A loss of communications system for an aircraft includes a fault module configured to detect a fault condition of the aircraft, and an emergency communication module configured to connect to a network, and to transmit condition data of the aircraft over the network when the fault condition is detected. The fault condition can include at least one of a loss of communication between the aircraft and a remote user or a forced landing of the aircraft. The condition data can include at least one of current location data, aircraft system health data, landing site location data, or landing site characteristics data.

The emergency communication module can be configured to connect to the network via at least one of a satellite or a wifi router. The emergency communication module can be configured to compile all condition data and transmit the condition data in a single blast communication over the network. The blast communication can include at least one of a text message or email.

The aircraft can be an unmanned aerial vehicle (UAV) including a non-transitory memory and a processor. The fault module and/or the communication module can include software stored on the non-transitory memory of the UAV, wherein the software is executable by the processor of the UAV.

A method includes detecting a fault condition of an aircraft, connecting to a network if the fault condition is detected, and transmitting condition data over the network. Detecting a fault condition can include detecting if there is a loss of communication between the aircraft and a remote user or detecting a forced landing of the aircraft.

Connecting to a network can include connecting to the internet using a satellite or wifi router. Transmitting condition data over the network can include compiling condition data and transmitting the condition data in a single blast communication over the network.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a system in accordance with this disclosure; and

FIG. 2 is a flow chart of an embodiment of a method in accordance with this disclosure.

### DETAILED DESCRIPTION

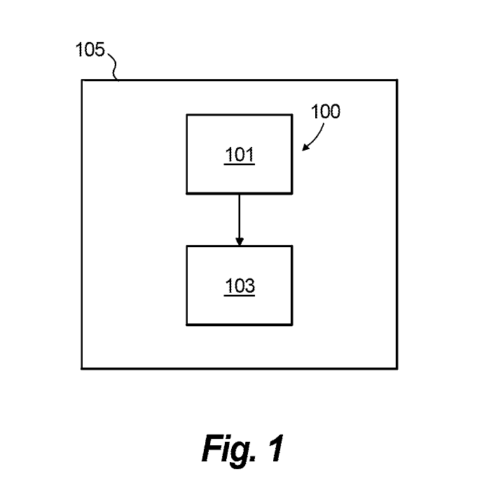

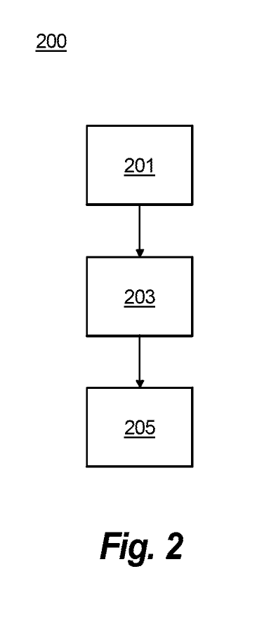

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIG. 2. The systems and methods described herein can be used to locate and/or monitor an aircraft when loss of communication occurs.

Referring to FIG. 1, a loss of communications system 100 for an aircraft (not shown) includes a fault module 101 configured to detect a fault condition of the aircraft. The system 100 further includes an emergency communication module 103 configured to connect to a network and to transmit condition data of the aircraft over the network when the fault condition is detected.

The aircraft can be an unmanned aerial vehicle (UAV) including a non-transitory memory and a processor, for example. The fault module and/or the communication module can include software stored on the non-transitory memory of the UAV, wherein the software is executable by the processor of the UAV. The fault module 101 and/or the emergency communication module 103 can include any suitable hardware (e.g., a non-transitory memory, processor, a suitable wireless transmitter, and/or any other suitable electronics) and/or any suitable software to perform their respective functions. In certain embodiments, the fault module 101 and/or the emergency communication module 103 can be included in a controller 105 of the UAV.

In certain embodiments, the fault condition can include at least one of a loss of communication between the aircraft and a remote user. For example, an aircraft may be remotely piloted, controlled, or monitored (e.g., while on a preprogrammed flight) by the remote user and may fly out of line of sight (LOS) of a communication beacon such that communication with the aircraft is lost. In this case, the fault module 101 can detect that communication has been lost and indicate to the emergency communication module 103 that a fault condition exists. The controller 105 can automatically determine the best landing position and land the UAV if loss of communication is detected.

In certain embodiments, loss of communication alone may not be enough to trigger a fault condition as long as the UAV is operating within predetermined limits and/or along a predetermined flight plan, for example. In this case, a condition that causes a forced landing of the aircraft (e.g., engine/motor failure, flight instability, weather) can be the fault condition.

In the fault condition, and if the aircraft is out of LOS and cannot communicate with a user, for example, the emergency communication module 105 can detect and connect to a network in any suitable manner. For example, the emergency communication module 105 can be configured to connect to the network (e.g., the internet) via at least one of a satellite, a wifi router, or any other suitable network access point (e.g., a cell tower) to transmit the condition data to the user. For example, the emergency communication module 105 can connect to a cell connection, such as a 3G or 4G connection (e.g., via a cell tower and/or via one or more other drones within in communication distance). In certain embodiments, additional aircraft (e.g., UAV's) could be used as reach back links as airborne cell towers/satellites so as to extend range.

The condition data can include at least one of current location data, aircraft system health data, landing site location data, or landing site characteristics data (e.g., terrain information, images, or the like). Any other suitable data is contemplated herein for transmission to the user over the network.

In certain embodiments, the emergency communication module 105 can be configured to compile all desired condition data and transmit the condition data in a single blast communication over the network. The blast communication can include at least one of a text message or email.

Referring to FIG. 2, a method 200 can include detecting (e.g., at block 201) a fault condition of an aircraft, connecting (e.g., at block 203) to a network if the fault condition is detected, and transmitting (e.g., at block 205) condition data over the network. Detecting a fault condition can include detecting if there is a loss of communication between the aircraft and a remote user or detecting a forced landing of the aircraft. Connecting to a network can include connecting to the internet using a satellite or wifi router. Transmitting condition data over the network can include compiling condition data and transmitting the condition data in a single blast communication over the network. Embodiments of method 200 can be stored on and/or executed by a controller 105 of an aircraft (e.g., via any suitable hardware and/or software).

As described above, a UAV or other aircraft in a loss communication situation with base station or beyond LOS and encountering a mission abort requirement can automatically connect to nearest network (e.g., an internet connection) and text or email condition data (e.g., health status and auto landing position for easy recovery).

The methods and systems of the present disclosure, as described above and shown in the drawings, provide for aircraft recovery systems with superior properties including emergency condition reporting over a suitable network. While the apparatus and methods of the subject disclosure have been shown and described with reference to embodiments, those skilled in the art will readily appreciate that changes and/or modifications may be made thereto without departing from the spirit and scope of the subject disclosure.

1. A loss of communications system for an aircraft, comprising:
a fault module configured to detect a loss of communication between the aircraft and a remote user due to the aircraft being out of communication with a base station or out of a line of sight (LOS); and
an emergency communication module configured to connect to a network, and to transmit condition data of the aircraft over the network when the fault condition is detected.

2. The system of claim 1, wherein the emergency communication module is configured to use one or more other aircraft as reach back links for communication if a loss of communication is detected.

3. The system of claim 1, wherein the condition data includes at least one of current location data, aircraft system health data, landing site location data, or landing site characteristics data.

4. The system of claim 1, wherein the emergency communication module is configured to connect to the network via at least one of a satellite or a wifi router.

5. The system of claim 1, wherein the emergency communication module is configured to compile all condition data and transmit the condition data in a single blast communication over the network.

6. The system of claim 5, wherein the blast communication includes at least one of a text message or email.

7. The system of claim 1, wherein the aircraft is an unmanned aerial vehicle (UAV) including a non-transitory memory and a processor.

8. The system of claim 7, wherein the fault module and/or the communication module include software stored on the non-transitory memory of the UAV, wherein the software is executable by the processor of the UAV.

9. A method, comprising:
detecting if there is a loss of communication between an aircraft and a remote user or detecting a forced landing of the aircraft;
connecting to a network if the loss of communication is detected; and
transmitting condition data over the network.

10. The method of claim 9, wherein connecting to a network includes using one or more other aircraft as reach back links for communication.

11. The method of claim 9, wherein connecting to a network includes connecting to the internet using a satellite or wifi router.

12. The method of claim 9, wherein transmitting condition data over the network includes compiling condition data and transmitting the condition data in a single blast communication over the network.
